(19) United States
(12) Patent Application Publication
(10) Pub. No.: US 2015/0276977 A1
(43) Pub. Date: Oct. 1, 2015

(54) PHOTOELECTRIC PEOPLE COUNTING DEVICE

(71) Applicant: Joe Varacalli, Youngstown, OH (US)

(72) Inventor: Joe Varacalli, Youngstown, OH (US)

(73) Assignee: SENSOURCE INC., Youngstown, OH (US)

(21) Appl. No.: 14/227,114

(22) Filed: Mar. 27, 2014

(51) Int. Cl. G01V 8/20; H04B 7/24

(52) U.S. Cl. CPC G01V 8/20; H04B 7/24

(57) ABSTRACT

Embodiments of the invention may include a low-power people-counting system and related methods. Such a system may include a pair of uncollimated light sources operating at a relatively low duty cycle. Light from the sources may be detected using devices adapted to discriminate between light based on the source from which it was omitted.

### I. BACKGROUND OF THE INVENTION

A. Field of Invention

Embodiments may generally relate to low-power devices for counting people.

B. Description of the Related Art

In general, optical beam break devices for counting people are well known; however, existing devices have a number of shortcomings. For instance, many existing devices require a sufficiently high amount of power to make batteries an impractical power source. Such devices typically must be hard wired to a grid electrical service. This makes installation more complex, and may require the services of an electrician to wire the device. The requirement for a hard wired power source also adds cost to the device because it requires a power inverter and possibly other power conditioning electronics. Low-power devices have been developed that can feasibly run on batteries; however, known devices employ complex synchronization electronics to synchronize the operation of a light source with a detector thereby limiting the required on-time of the light source.

People counting devices capable of detecting direction of travel are also known in general, but leave a gap in the art especially in the area of discriminating between signals from specific light sources. More particularly, the problem being solved comes from the way in which directionality is typically determined. In general two light sources are provided and directionality is determined based on the order in which the beams are broken. One approach is to space the light sources sufficiently far apart that their beams do not overlap at their respective detectors. Another approach has been to pulse the light sources according to distinct waveforms. Designs using this approach can detect both beams with a common detector, and can determine the beam break state based on the waveform being detected, i.e. the waveform of the first light source, the second light source, or the superposition of both waveforms. While using distinctive light pulse waveforms allows light sources to be placed closer together and permits the use of low cost uncollimated sources, it would be desirable to have a simpler design that also permits the use of low cost uncollimated sources.

Some embodiments of the present invention may provide one or more benefits or advantages over the prior art.

### II. SUMMARY OF THE INVENTION

Some embodiments may relate to a low-power people-counting system, comprising: at least a first uncollimated light source, wherein the first light source operates according to a duty cycle between about 0.1% and 10%; and at least a first light detector adapted to continuously and selectively sense radiant output of the first light source.

Embodiments may further comprise a second uncollimated light source having a predetermined fixed spacing between the first and second light sources along a direction of travel of an arbitrary body, wherein the first and second light sources differ in one or more of frequency or polarization, and further comprising a second light detector adapted to continuously and selectively sense radiant output of the second light source.

According to some embodiments the first and second light detectors each include one or more filters for selectively detecting the radiant output of the first or second lights sources.

According to some embodiments each of the first and second detectors can be simultaneously in optical communication with both of the first and second light sources, and are adapted to discriminate between the radiant output of the first light source and the radiant output of the second light source according to differing frequencies and/or polarizations thereof.

According to some embodiments the first and second light detectors are adapted to operate according to a 100% duty cycle.

According to some embodiments the first and/or second light sources operate according to a duty cycle between about 0.1% and 0.5%, 0.5% and 1%, 1% and 1.5%, 1.5% and 2.0%, 2.0% and 2.5%, 2.5% and 3.0%, 3.0% and 3.5%, 3.5% and 4.0%, 4.0% and 4.5%, 5.0% and 5.5%, 5.5% and 6.0%, 6.0% and 6.5%, 6.5% and 7.0%, 7.0% and 7.5%, 7.5% and 8.0%, 8.0% and 8.5%, 8.5% and 9.0%, 9.0% and 9.5%, 9.5% and 10% or any combination thereof.

According to some embodiments the first and second light sources each have an on-state pulse width between about 1 μs and 1000 μs.

According to some embodiments the first and second light sources each have an on-state pulse width between about 1 μs and 10 μs, 10 μs and 15 μs, 15 to 50 μs, 50 to 100 μs, 100 to 150 μs, 150 to 200 μs, 200 to 250 μs, 250 to 300 μs, 300 to 350 μs, 350 to 400 μs, 400 to 450 μs, 450 to 500 μs, 500 to 550 μs, 550 to 600 μs, 600 to 650 μs, 650 to 700 μs, 750 to 800 μs, 800 to 850 μs, 850 to 900 μs, 900 to 950 μs, 950 to 1000 μs, or any combination thereof.

According to some embodiments the fixed spacing between the first and second light sources is between about 1 cm and 100 cm.

According to some embodiments the first and second light sources are in line-of-sight optical communication with the first and second light detectors.

Embodiments may further comprise means of determining the direction of travel of an arbitrary body passing between the first and second light sources and the first and second light detectors based on the order in which a first light beam and a second light beam are broken.

Embodiments may further comprise a radio frequency transmitter adapted to broadcast digital data packets encoding data from the first and second light detectors.

Embodiments may further comprise a radio frequency receiver adapted to receive the digital data packets transmitted by the transmitter and communicate the digital data packets to an external computer.

According to some embodiments the radio frequency transmitter and the radio frequency receiver lack circuitry and/or programming for affirmatively avoiding data packet collisions.

Embodiments may relate to a low-power people-counting system, comprising: a first uncollimated light source and a second uncollimated light source having a predetermined fixed spacing therebetween and disposed along a direction of travel of an arbitrary body, wherein the first and second light sources differ in one or more of frequency or polarization, and wherein the first and second light sources operate according to a duty cycle between about 0.1% and 10%; a first light detector adapted to continuously and selectively sense radiant output of the first light source; and a second light detector adapted to continuously and selectively sense radiant output of the second light source.

Embodiments may further comprise means of determining the direction of travel of an arbitrary body passing between the first and second light sources and the first and second light detectors based on the order in which a first light beam and a second light beam are broken.

Embodiments may further comprise a radio frequency transmitter adapted to broadcast digital data packets encoding data from the first and second light detectors.

Embodiments may further comprise a radio frequency receiver adapted to receive the digital data packets transmitted by the transmitter and communicate the digital data packets to an external computer.

According to some embodiments the radio frequency transmitter and the radio frequency receiver lack circuitry and/or programming for affirmatively avoiding data packet collisions.

Embodiments may relate to a low-power people-counting system, comprising: a first uncollimated light source and a second uncollimated light source having a predetermined fixed spacing therebetween and disposed along a direction of travel of an arbitrary body, wherein the first and second light sources differ in one or more of frequency or polarization, and wherein the first and second light sources operate according to a duty cycle between about 0.1% and 10%; a first light detector adapted to continuously and selectively sense radiant output of the first light source; a second light detector adapted to continuously and selectively sense radiant output of the second light source; a means of determining the direction of travel of an arbitrary body passing between the first and second light sources and the first and second light detectors based on the order in which a first light beam and a second light beam are broken; a radio frequency transmitter adapted to broadcast digital data packets encoding data from the first and second light detectors; and a radio frequency receiver adapted to receive the digital data packets transmitted by the transmitter and communicate the digital data packets to an external computer, wherein the radio frequency transmitter and the radio frequency receiver lack circuitry and/or programming for affirmatively avoiding data packet collisions.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1A is a schematic drawing illustrating an optical arrangement according to one embodiment where an arbitrary body is out of the field of view;

FIG. 1B is the optical arrangement of FIG. 1A where the arbitrary body is breaking a first beam;

FIG. 1C is the optical arrangement of FIG. 1A where the arbitrary body is breaking a second beam;

FIG. 2A is a schematic diagram showing an optical arrangement according to a second embodiment where an arbitrary body is outside the field of view;

FIG. 2B is a schematic diagram showing the optical arrangement of FIG. 2A where the arbitrary body is breaking both beams simultaneously;

FIG. 3A illustrates a simplified optical arrangement having one source and one detector for the purpose of illustrating the collection of data points from an arbitrary body breaking the optical beam;

FIG. 3B is a graph showing a pulse pattern according to an embodiment; and

FIG. 4 is schematic diagram of a system according to one embodiment.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Embodiments may comprise low-powered devices and systems for counting arbitrary bodies such as objects or people by detecting optical beam breaks. According to some embodiments, low power consumption can be achieved even with a detector operating in an always-on configuration, and may do so by operating one or more optical sources at low or very low duty cycles. Embodiments may optionally include means for wired or wirelessly transmitting beam break data and/or data derived therefrom to a remote base station or directly through a wired or wireless network where the data may be communicated to a computer system for processing and storage. Suitable means for transmitting such data may lack any programming or other means for affirmatively avoiding data packet collisions and may instead rely on the relatively low probability that a collision will occur.

In one optical configuration of an embodiment a light source may be in line-of-sight communication with a light detector. Such configurations are suitable for counting passing bodies, but are not suitable for detecting their direction of travel using beam breaks. An alternative optical configuration capable of detecting direction of travel includes at least a second light source and at least a second light detector. The first and second light sources may be separated by a distance which may be a fixed distance. The first and second light detectors may be closely spaced, and may even be spaced so that both detectors are illuminated by both light sources simultaneously. In such embodiments with overlapping fields of view, the first and second light sources may be distinguishable by having detectably different frequencies and/or polarizations. Accordingly, in one embodiment filters may be interposed between the light sources and light detectors so that each of the respective light detectors are adapted to sense only one of the two light sources. Thus, the light from a light source may be selectively detected. The light beams being distinguishable, one skilled in the art will appreciate that direction of travel can be inferred by beam break order.

Some multi light source embodiments may distinguish between the light sources by mathematically deconvoluting their signals according to known transform techniques. Such embodiments may omit filter optics, and may use a single light detector rather than dedicating a detector to each light source. Moreover, some single light source embodiments may be capable of detecting direction of travel by measuring Doppler shift. For instance, a radio source may direct a known-frequency signal onto an arbitrary body passing through an optical path of an embodiment, and a receiver may be positioned to receive backscatter. The frequency of the backscattered signal may be determined according to known means and the direction of travel can be established by determining whether the shift is positive or negative.

Suitable light sources according to embodiments of the invention may operate in the radio, near infrared (NIR), visible, or even ultraviolet (UV) regions of the electromagnetic spectrum. NIR sources may offer certain advantages because the beam energy is lower than that of visible and UV sources, thereby reducing input power requirements. Additionally, NIR radiation is invisible and therefore may go unnoticed by, for instance, persons traversing an entryway, which may be regarded as less intrusive to the person being monitored.

Examples of suitable NIR sources include light emitting diodes (LEDs) operating in the NIR range as well as resistive heating elements. While, much of this specification is dedicated to low-cost uncollimated sources and low-power sources, one skilled in the art will recognize that NIR lasers may also be suitable sources, and would foreclose the need for filter optics or deconvolution methods for discriminating between beams. However, among the available NIR sources, non-laser NIR LEDs may offer certain advantages because they tend to be low in cost, and have lower power consumption characteristics than resistive heating elements and NIR lasers.

One skilled in the art will appreciate that suitable light detectors depend in part upon the selected light source. For instance, if the light source is in the radio or microwave regions of the spectrum then an antenna would be suitable. Photodiodes having various spectral sensitivities may be used to detect NIR, visible, and UV. For example, silicon photodiodes are often used for UV and visible light detection due to their sensitivity typically between about 190 nm and 1100 nm. A variety of semiconductive materials are used for infrared and near infrared photodiodes, as well as detectors functioning in other modes such as photoconductive, photovoltaic, pyroelectric, or bolometric modes. Table 1 sets forth a number of materials commonly used in infrared detectors and their spectral sensitivity ranges in micrometers (μm).

TABLE 1

| Material | Mode | Spectral Range (μm) |
|---|---|---|
| Lead sulfide (PbS) | photoconductive | 1-3.2 |
| Lead selenide (PbSe) | photoconductive | 1.5-5.2 |
| Indium antimonide (InSb) | photoconductive | 1-6.7 |
| Mercury cadmium telluride | photoconductive | 0.8-25 |
| (MCT, HgCdTe) | | |
| Mercury zinc telluride | photoconductive | |
| (MZT, HgZnTe) | | |
| Indium gallium arsenide | photodiode | 0.7-2.6 |
| (InGaAs) | | |
| Germanium | photodiode | 0.8-1.7 |
| Indium antimonide (InSb) | photodiode | 1-5.5 |
| Indium arsenide (InAs) | photovoltaic | 1-3.8 |
| Platinum silicide (PtSi) | photovoltaic | 1-5 |
| Lithium tantalate (LiTaO3) | pyroelectric | |
| Triglycine sulfate | pyroelectric | |
| (TGS and DTGS) | | |

In general, light detectors tend to consume far less energy than light sources. A comparison of several NIR components is illustrative. A survey of randomly selected NIR LED sources show that many operate around 20 to 50 mW, while many NIR resistive heating element sources operate around 400 to 500 mW. In comparison, a survey of randomly selected NIR detectors shows that they tend to operate around 20 to 50 μW. Thus, detector components may operate at three orders of magnitude lower power than NIR LEDs and four orders of magnitude lower than NIR resistive heating elements. Therefore, the greatest power savings can be achieved through modulating the source rather than the detector. Furthermore, by operating the detector at a 100% duty cycle, there is no need for complex synchronization circuitry to allow the source and detector to reliably communicate.

Embodiments of the invention may modulate an NIR LED source, for instance, so that the on-state to on-state period is small enough that the embodiment would see a beam break for the thinnest and fastest-moving object that the system is intended to detect. Furthermore, on-state pulse width may also be modulated so more or fewer pulses can span a given time period while maintaining the same percent duty cycle.

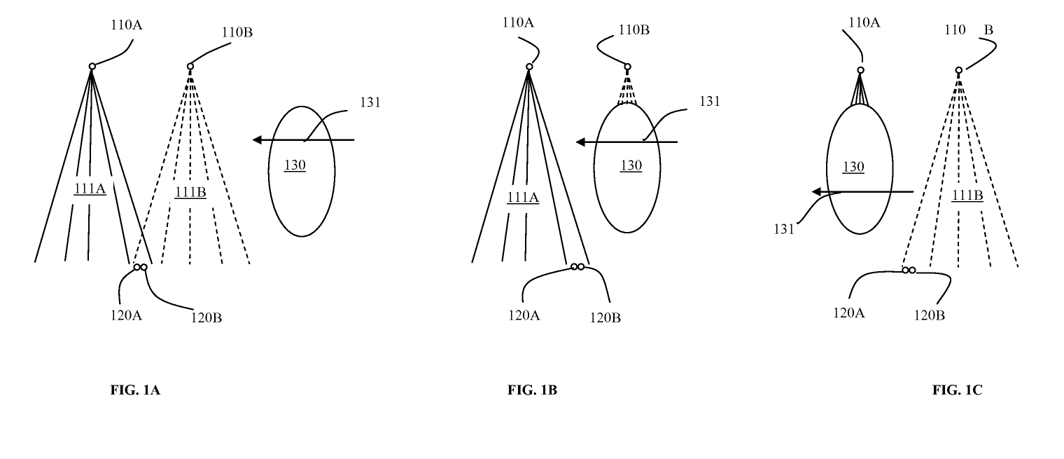

Referring now to the drawings wherein the showings are for purposes of illustrating embodiments of the invention only and not for purposes of limiting the same, FIG. 1A through 1C are diagrams showing an optical configuration according to one embodiment. As shown in FIG. 1A a first light source 110A and a second light source 110B simultaneously illuminate a first light detector 120A and a second light detector 120B with their respective cone beams 111A and 11B, which are shown overlapping. An arbitrary body 130 is shown moving in the direction of arrow 131. FIG. 1A illustrates the condition where both beams 111A and 111B are unbroken. FIG. 1B illustrates beam 111B being broken by body 130, and FIG. 1C illustrates beam 111A being broken some time later. Thus, the direction of travel can be established as right to left corresponding to the order in which the beams are broken.

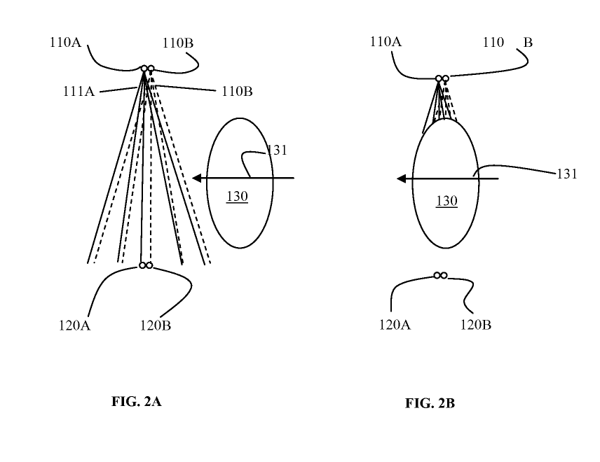

FIGS. 2A and 2B illustrate an optical configuration according to a second embodiment wherein the first source 110A and the second source 110B are much closer than as shown in FIG. 1A-C. In fact, in FIGS. 2A and 2B the cone beams of the respective sources substantially overlap. Accordingly, the time difference between the first being broken and the second beam being broken would be commensurately shorter than in FIG. 1A-C where the sources are farther apart.

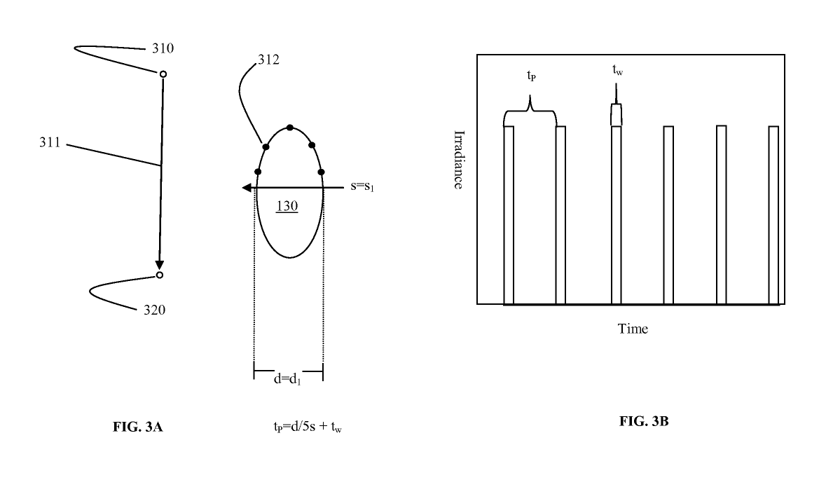

Turning to FIG. 3A, we begin to address the period between on states of light sources. The optical layout is simplified for the purpose of explanation to a single source 310, with a single ray 311, and a single detector 320 sensing the ray 311. In theory, the source 310 must turn on at least once while an arbitrary body 130 breaks the optical path between the source 310 and detector 320 in order for the object 130 to be detected. However, it may be preferable in some embodiments to have more than one beam break data point in order to be confident that a body 130 is in fact present. FIG. 3A illustrates five impingement points 312 on the body 130 where the ray 311 will strike the body resulting in a beam break condition. Importantly, this is merely an example for the purpose of illustration and is not intended to limit the invention to collecting five pulses, or even approximately five pulses, per body 130.

Continuing with this example, if the body 130 is to break a pulsed beam N number of times, and the body 130 has a thickness “d” and is traveling at speed “s” then the period tₚ would be given by Equation 1 (Eq. 1), assuming that the pulse width t_{w} of the source is negligible, or Equation 2 (Eq. 2) where pulse width t_{w} is non-negligible. A graph of the period and pulse pattern according to one embodiment is shown in FIG. 3B.

$$\begin{matrix}{t}_{p} = \frac{d}{Ns} & Eq . 1 \\ {t}_{p} = \frac{d}{Ns} + {t}_{w} & Eq . 2\end{matrix}$$

Accordingly, selection of a proper frequency for switching a light source may vary depending on the expected size of the body to be measured and the speed at which it is expected to travel.

Suitable light source pulse widths may be from about 1 μs to about 1000 μs. In one particular embodiment, a suitable pulse width may be from about 10 to 15 μs; however, other suitable pulse widths may be from about 10 to 50 μs, 50 to 100 μs, 100 to 150 μs, 150 to 200 μs, 200 to 250 μs, 250 to 300 μs, 300 to 350 μs, 350 to 400 μs, 400 to 450 μs, 450 to 500 μs, 500 to 550 μs, 550 to 600 μs, 600 to 650 μs, 650 to 700 μs, 750 to 800 μs, 800 to 850 μs, 850 to 900 μs, 900 to 950 μs, 950 to 1000 μs, or any combination thereof.

Suitable frequencies for switching a light source may be from about 5 Hz to about 10 GHz. In one particular embodiment a suitable range is from about 30 kHz to 50 kHz; however, in other embodiments suitable ranges may be from about 5 to 10 Hz, 10 to 100 Hz, 100 to 1000 Hz, 1000 to 10⁴ Hz, 10⁴ Hz to 10⁵ Hz, 10⁵ Hz to 10⁶ Hz, 10⁶ Hz to 10⁷ Hz, 10⁷ Hz to 10⁸ Hz, 10⁸ Hz to 10⁹ Hz, 10⁹ Hz to 10¹⁰ Hz, or any combination thereof. One skilled in the art will appreciate that suitable ranges depend in part on the particular components chosen to construct an embodiment.

Suitable duty cycles for a power source may be from about 0.1% to 10%. In one particular embodiment a suitable duty cycle may be from about 0.4 to 0.6%; however, other duty cycles may be from about 0.1% to 0.5%, 0.5% to 1.0%, 1.0% to 1.5%, 1.5% to 2.0%, 2.0% to 2.5%, 2.5% to 3.0%, 3.0% to 3.5%, 3.5% to 4.0%, 4.0% to 4.5%, 4.5% to 5.0%, 5.0% to 5.5%, 5.5% to 6.0%, 6.0% to 6.5%, 6.5% to 7.0%, 7.0% to 7.5%, 7.5% to 8.0%, 8.0% to 8.5%, 8.5% to 9.0%, 9.0% to 9.5%, 9.5% to 10%, or any combination thereof.

According to one embodiment, determining whether a beam break condition should be recorded as a count of a passing body may include detecting changes in the period of pulses detected. For instance, if a single pulse is obstructed, then the period detected should change from tₚ to 2tₚ, and if two consecutive pulses are obstructed then the period should change from tₚ to 3tₚ, and so on. Some embodiments may require a predetermined number of consecutive obstructed pulses before counting a body. For instance, if a given embodiment is designed to be obstructed for a time-equivalent of 10 consecutive pulses on average, then it may be reasonable to require at least three to five consecutive obstructed pulses before counting a body.

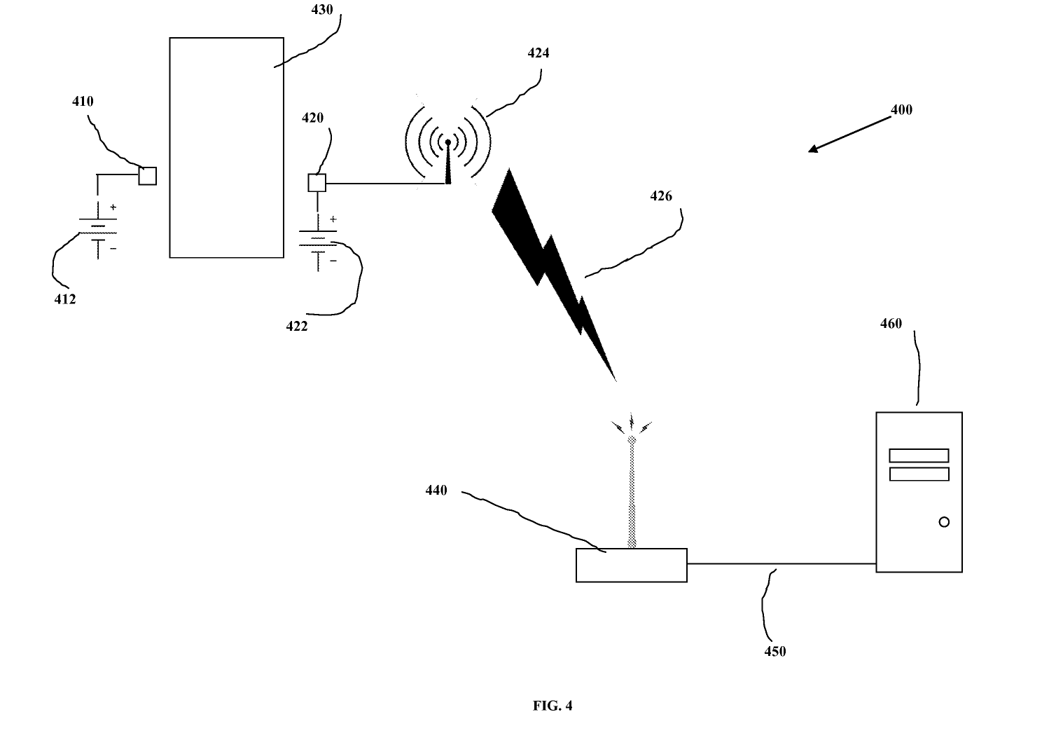

FIG. 4 is a diagram of an installed system 400 according to an embodiment of the invention. A light source 410 is positioned on one side of a doorway 430 and is powered by a battery 412. A detector 420 is positioned on the opposing side of the doorway 430. In this embodiment 400 the detector 420 is also powered by a battery 412. Data collected by the detector 420 is wirelessly transmitted 426 by a transmitter 424 to a remote base station 440. The remote base station then communicates the data to an external computer 460. In the embodiment of FIG. 4, the remote base station 440 is connected to the computer 460 via a hardwired connection; however, the connection may be wireless. Furthermore, the remote base station 440 may comprise an electronics card installed in the computer 460 rather than a freestanding device as shown. The remote base station 440 may be configured to communicate with a plurality of independently operating transmitters 424 operating in asynchronous mode. Furthermore, the base station 440 and the transmitters 424 may lack any special programming or features for avoiding data packet collisions, and instead may rely on the inherently low probability of a collision due to the short pulse width of a data packet.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/we claim:

1. A low-power people-counting system, comprising:
at least a first uncollimated light source, wherein the first light source operates according to a duty cycle between about 0.1% and 10%; and
at least a first light detector adapted to continuously and selectively sense radiant output of the first light source.

2. The system of claim 1, further comprising a second uncollimated light source having a predetermined fixed spacing between the first and second light sources along a direction of travel of an arbitrary body, wherein the first and second light sources differ in one or more of frequency or polarization, and further comprising a second light detector adapted to continuously and selectively sense radiant output of the second light source.

3. The system of claim 2, wherein the first and second light detectors each include one or more filters for selectively detecting the radiant output of the first or second lights sources.

4. The system of claim 2, wherein each of the first and second detectors can be simultaneously in optical communication with both of the first and second light sources, and are adapted to discriminate between the radiant output of the first light source and the radiant output of the second light source according to differing frequencies and/or polarizations thereof.

5. The system of claim 2, wherein the first and second light detectors are adapted to operate according to a 100% duty cycle.

6. The system of claim 2, wherein the first and/or second light sources operate according to a duty cycle between about 0.1% and 0.5%, 0.5% and 1%, 1% and 1.5%, 1.5% and 2.0%, 2.0% and 2.5%, 2.5% and 3.0%, 3.0% and 3.5%, 3.5% and 4.0%, 4.0% and 4.5%, 5.0% and 5.5%, 5.5% and 6.0%, 6.0% and 6.5%, 6.5% and 7.0%, 7.0% and 7.5%, 7.5% and 8.0%, 8.0% and 8.5%, 8.5% and 9.0%, 9.0% and 9.5%, 9.5% and 10% or any combination thereof.

7. The system of claim 2, wherein the first and second light sources each have an on-state pulse width between about 1 μs and 1000 μs.

8. The system of claim 7, wherein the first and second light sources each have an on-state pulse width between about 1 μs and 10 μs, 10 μs and 15 μs, 15 to 50 μs, 50 to 100 μs, 100 to 150 μs, 150 to 200 μs, 200 to 250 μs, 250 to 300 μs, 300 to 350 μs, 350 to 400 μs, 400 to 450 μs, 450 to 500 μs, 500 to 550 μs, 550 to 600 μs, 600 to 650 μs, 650 to 700 μs, 750 to 800 μs, 800 to 850 μs, 850 to 900 μs, 900 to 950 μs, 950 to 1000 μs, or any combination thereof.

9. The system of claim, 2 wherein the fixed spacing between the first and second light sources is between about 1 cm and 100 cm.

10. The system of claim 2, wherein the first and second light sources are in line-of-sight optical communication with the first and second light detectors.

11. The system of claim 2, further comprising means of determining the direction of travel of an arbitrary body passing between the first and second light sources and the first and second light detectors based on the order in which a first light beam and a second light beam are broken.

12. The system of claim 2, further comprising a radio frequency transmitter adapted to broadcast digital data packets encoding data from the first and second light detectors.

13. The system of claim 12, further comprising a radio frequency receiver adapted to receive the digital data packets transmitted by the transmitter and communicate the digital data packets to an external computer.

14. The system of claim 13, wherein the radio frequency transmitter and the radio frequency receiver lack circuitry and/or programming for affirmatively avoiding data packet collisions.

15. A low-power people-counting system, comprising:
a first uncollimated light source and a second uncollimated light source having a predetermined fixed spacing therebetween and disposed along a direction of travel of an arbitrary body, wherein the first and second light sources differ in one or more of frequency or polarization, and wherein the first and second light sources operate according to a duty cycle between about 0.1% and 10%;
a first light detector adapted to continuously and selectively sense radiant output of the first light source; and
a second light detector adapted to continuously and selectively sense radiant output of the second light source.

16. The system of claim 15, further comprising means of determining the direction of travel of an arbitrary body passing between the first and second light sources and the first and second light detectors based on the order in which a first light beam and a second light beam are broken.

17. The system of claim 15, further comprising a radio frequency transmitter adapted to broadcast digital data packets encoding data from the first and second light detectors.

18. The system of claim 17, further comprising a radio frequency receiver adapted to receive the digital data packets transmitted by the transmitter and communicate the digital data packets to an external computer.

19. The system of claim 18, wherein the radio frequency transmitter and the radio frequency receiver lack circuitry and/or programming for affirmatively avoiding data packet collisions.

20. A low-power people-counting system, comprising:
a first uncollimated light source and a second uncollimated light source having a predetermined fixed spacing therebetween and disposed along a direction of travel of an arbitrary body, wherein the first and second light sources differ in one or more of frequency or polarization, and wherein the first and second light sources operate according to a duty cycle between about 0.1% and 10%;
a first light detector adapted to continuously and selectively sense radiant output of the first light source;
a second light detector adapted to continuously and selectively sense radiant output of the second light source;
a means of determining the direction of travel of an arbitrary body passing between the first and second light sources and the first and second light detectors based on the order in which a first light beam and a second light beam are broken;
a radio frequency transmitter adapted to broadcast digital data packets encoding data from the first and second light detectors; and
a radio frequency receiver adapted to receive the digital data packets transmitted by the transmitter and communicate the digital data packets to an external computer, wherein the radio frequency transmitter and the radio frequency receiver lack circuitry and/or programming for affirmatively avoiding data packet collisions.
